(19) United States
(12) Patent Application Publication
(10) Pub. No.: US 2015/0312876 A1
(43) Pub. Date: Oct. 29, 2015

(54) MONITORING A QUALITY OF A TERRESTRIAL RADIO BASED POSITIONING SYSTEM

(71) Applicants: Jari SYRJÄRINNE, Tampere (FI); Lauri Aarne Johannes WIROLA, Tampere (FI); Tommi Antero LAINE, Tampere (FI)

(72) Inventors: Jari SYRJÄRINNE, Tampere (FI); Lauri Aarne Johannes WIROLA, Tampere (FI); Tommi Antero LAINE, Tampere (FI)

(73) Assignee: Nokia Corporation, Espoo (FI)

(21) Appl. No.: 14/384,377

(22) PCT Filed: Mar. 15, 2012
(86) PCT No.: PCT/IB2012/051225

§ 371 Date: Dec. 28, 2014

(51) Int. Cl. H04W 64/00; G01S 5/02; H04B 17/26

(52) U.S. Cl. CPC H04W 64/00; H04B 17/26; G01S 5/0252

(57) ABSTRACT

An apparatus generates at least one request for determination of a location of a mobile device based on information on terrestrial radio signals determined by the mobile device and based on stored positioning data. The stored positioning data is based on information on terrestrial radio signals provided by at least one mobile device. The apparatus further determines a value of at least one quality parameter by evaluating a response to the request in view of an indication of a position of the mobile device that has been determined based on satellite signals.

### FIELD OF THE DISCLOSURE

The invention relates to the field of positioning, and more specifically to the monitoring of the quality of positioning information.

### BACKGROUND

Terrestrial positioning has become the backbone for location based services (LBS), especially for social location apps running on smartphones, tablets, laptops and other portable devices, as provided for instance by Facebook or Foursquare.

Terrestrial positioning is mostly based on radio signals transmitted by nodes of a communication network, like cell towers of cellular communication networks and access points (AP) of wireless local area networks (WLAN). Other types of non-cellular terrestrial radio signals, like signals transmitted by Bluetooth beacons, may be considered as well.

The location of the nodes and other information on the nodes may be stored in large global databases. The information may be gathered in a learning process based on so called “fingerprints” that are generated by mobile devices and provided to a server. A fingerprint typically comprises the results of measurements on terrestrial radio signals at the mobile device, an indication of the location of the mobile device and a timestamp indicating the time of measurement. In the case of measurements on cellular signals, the results of the measurements may contain a global and/or local identification of the cellular network cells observed, their signal strengths and/or pathlosses and/or timing measurements like timing advance (TA) or round-trip time. In the case of measurements on WLAN signals, the results of the measurements may contain a basic service set identification (BSSID), like the medium access control (MAC) address of observed access points, the service set identifier (SSID) of the access points, and the signal strength of received signals (received signal strength indication RSSI or physical Rx level in dBm with a reference value of 1 mW, etc.). Typically, the location of the fingerprint is measured at the mobile device with a reliable positioning sensor, for example with an integrated global positioning service (GPS) receiver.

The information for the database or databases may be gathered for example by “wardriving” or by crowd-sourcing.

Wardriving, which is applied for instance by Skyhook Inc., uses dedicated drivers and specific equipment to scan and map WLAN access points worldwide. Wardriving enables a managed approach for the data harvesting and provides a possibility of obtaining extremely good coverage in a very short time based on a limited amount of data with little redundancy. The data is collected and thus updated only occasionally. Thus, the databases could quickly become outdated, for example at locations in which the WLAN infrastructure is quickly changing or building up.

Crowd-sourcing is employed for instance by Google's, Nokia's and Apple's WLAN positioning services, which are using end-users' devices and platforms to harvest anonymous location measurements for the learning of WLAN access point and cellular tower location databases. Crowd-sourcing may rely on a constant and huge data inflow. Since the crowd-sourcing is based on users' activity and their usage of the location based services, the crowd-sourced data may be heavily biased on certain highly frequented areas, leaving sometimes some other areas almost void from observations. This may result in poor positioning performance in these areas. The data collected by crowd-sourcing may therefore be enhanced by dedicated data collection campaigns in order to improve coverage or accuracy where needed.

### SUMMARY OF SOME EMBODIMENTS OF THE INVENTION

A method is described, which comprises at an apparatus generating at least one request for determination of a location of a mobile device based on information on terrestrial radio signals determined by the mobile device and based on stored positioning data, wherein the stored positioning data is based on information on terrestrial radio signals provided by at least one mobile device. The method further comprises determining a value of at least one quality parameter by evaluating a response to the request in view of an indication of a position of the mobile device that has been determined based on satellite signals.

Moreover a first apparatus is described, which comprises means for realizing the actions of the presented method.

The means of this apparatus can be implemented in hardware and/or software. They may comprise for instance a processor for executing computer program code for realizing the required functions, a memory storing the program code, or both. Alternatively, they could comprise for instance circuitry that is designed to realize the required functions, for instance implemented in a chipset or a chip, like an integrated circuit.

Moreover a second apparatus is described, which comprises at least one processor and at least one memory including computer program code, the at least one memory and the computer program code configured to, with the at least one processor, cause an apparatus at least to perform the actions of the presented method.

Moreover a non-transitory computer readable storage medium is described, in which computer program code is stored. The computer program code causes an apparatus to realize the actions of the presented method when executed by a processor.

The computer readable storage medium could be for example a disk or a memory or the like. The computer program code could be stored in the computer readable storage medium in the form of instructions encoding the computer-readable storage medium.

The computer readable storage medium may be intended for taking part in the operation of a device, like an internal or external hard disk of a computer, or be intended for distribution of the program code, like an optical disc.

It is to be understood that also the computer program code by itself has to be considered an embodiment of the invention.

Moreover a system is described, which comprises any of the described apparatuses and a mobile device configured to determine and provide information on terrestrial radio signals.

Any of the described apparatuses may comprise only the indicated components or one or more additional components.

Any of the described apparatuses may be a module or a component for a device, for example a chip. Alternatively, any of the described apparatuses may be a device, for instance a server or a mobile terminal.

In one embodiment, the described method is an information providing method, and the described first apparatus is an information providing apparatus. In one embodiment, the means of the described first apparatus are processing means.

In certain embodiments of the described method, the method is a method for supporting a monitoring of a quality of information. In certain embodiments of the described apparatuses, the apparatuses are apparatuses for supporting a monitoring of a quality of information.

Further, it is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an apparatus according to an exemplary embodiment of the invention;

FIG. 2 is a flow chart illustrating a method according to an exemplary embodiment of the invention;

FIG. 3 is a schematic block diagram of a system according to an exemplary embodiment of the invention;

FIG. 4 is a flow chart illustrating an exemplary operation in the system of FIG. 3;

FIG. 5 is a diagram illustrating an exemplary fingerprint data structure; and

FIG. 6 is an alternative representation of an exemplary operation in the system of FIG. 3.

### DETAILED DESCRIPTION OF THE FIGURES

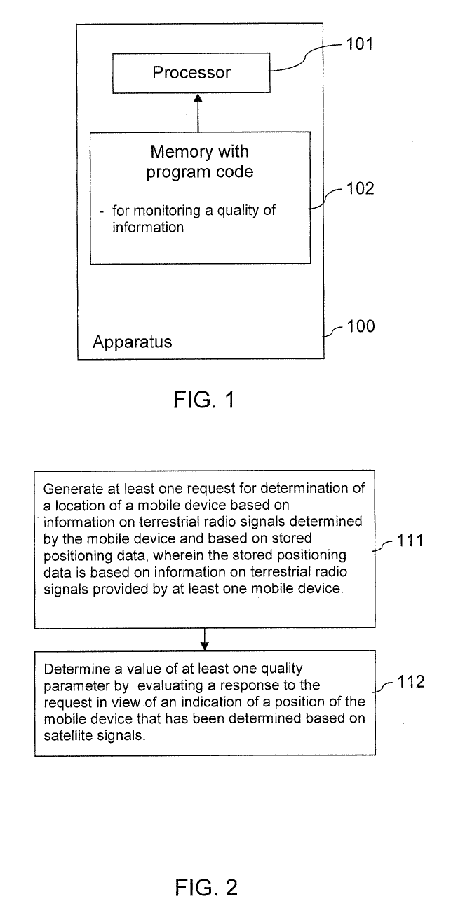

FIG. 1 is a schematic block diagram of an apparatus 100. Apparatus 100 comprises a processor 101 and, linked to processor 101, a memory 102. Memory 102 stores computer program code for supporting a monitoring of a quality of information. Processor 101 is configured to execute computer program code stored in memory 102 in order to cause an apparatus to perform desired actions.

Apparatus 100 could be a server or any other device, for instance a mobile terminal. Apparatus 100 could equally be a module for a server or for any other device, like a chip, circuitry on a chip or a plug-in board. Apparatus 100 is an exemplary embodiment of any apparatus according to the invention. Optionally, apparatus 100 could have various other components, like a data interface, a user interface, a further memory, a further processor, etc.

An operation of apparatus 100 will now be described with reference to the flow chart of FIG. 2. The operation is an exemplary embodiment of a method according to the invention. Processor 101 and the program code stored in memory 102 cause an apparatus to perform the operation when the program code is retrieved from memory 102 and executed by processor 101. The apparatus that is caused to perform the operation can be apparatus 100 or some other apparatus, in particular a device comprising apparatus 100.

The apparatus generates at least one request for determination of a location of a mobile device based on information on terrestrial radio signals determined by the mobile device and based on stored positioning data. The stored positioning data is based on information on terrestrial radio signals provided by at least one mobile device. (action 111) It is to be understood that the positioning data may but does not have to be stored at the apparatus. It is further to be understood that the mobile device may but does not have to be different from the at least one mobile device.

The apparatus furthermore determines a value of at least one quality parameter by evaluating a response to the request in view of an indication of a position of the mobile device that has been determined based on satellite signals. (action 112) It is to be understood that the response may but does not have to be provided by another apparatus.

Databases comprising information on nodes for the purpose of positioning may be huge. They may comprise for example hundred of millions of objects the quality of which, in terms of user experience in a positioning making use of these objects, is virtually impossible to monitor in real-time. Moreover, it is even more difficult to monitor how the quality of the databases are changing over time, that is, whether the perceived positioning accuracy from the end-user's point of view is improving or deteriorating in a certain area and/or with a certain type of network, for example with respect to a particular cellular operator in a particular country.

Certain embodiments of the invention may enable an apparatus to use information that is determined at a particular mobile device for checking the quality of stored positioning data. The stored positioning data may be based on information on terrestrial radio signals provided by at least one mobile device. The information determined at the particular mobile device comprises information on terrestrial radio signals, which may enable a positioning of the particular mobile device using the stored positioning data. The determined position of the particular mobile device, or information that a position of the particular mobile device cannot be determined based on the stored positioning data, may then be evaluated in view of a satellite signal based position that has been determined for the particular mobile device.

Certain embodiments of the invention may have the effect that they allow creating quality measures for existing services and databases. They may also be suited to provide a measure for the perceived end user positioning experience. Determining the quality of the stored positioning data based on actual measurements by mobile devices may provide more accurate information than, for example, simply estimating the quality by measuring the average size of the estimated WLAN AP or cell tower areas, or the number of updates, etc.

It is to be understood that while the presented embodiments are suited for monitoring the quality of positioning data that is based on crowd-sourced data, it could equally be used for monitoring the quality of managed and dedicated data collections.

Apparatus 100 illustrated in FIG. 1 and the operation illustrated in FIG. 2 may be implemented and refined in various ways.

The terrestrial radio signals may originate from various kinds of nodes. They could comprise for instance nodes of one or more cellular communication systems, for instance a global system for mobile communications (GSM), a 3rd Generation Partnership Project (3GPP) based cellular system like a wide-band code division multiple access (WCDMA) system or a time division synchronous CDMA (TD-SCDMA) system, a 3GPP2 system like a CDMA2000 system, a long term evolution (LTE) or LTE-Advanced system, or any other type of cellular system, like a worldwide interoperability for microwave access (WiMAX) system. The nodes of a cellular communication system could be for instance transceivers or base stations or cell towers of the cellular communication system. In general, a node of a cellular communication system could be an entity serving exactly one cell, or an entity serving a plurality of cells from a single position. Alternatively or in addition, the nodes could comprise for example nodes of one or more non-cellular communication systems, like WLAN, Bluetooth and Zigbee, etc. The node of a WLAN could be a WLAN access point.

The mobile device determining information on terrestrial radio signals may be for example a communication terminal, like a mobile phone, a smart phone, a laptop, a tablet computer, etc.

The information on terrestrial radio signals determined by the mobile device could be for example fingerprint data having the same structure and content that is used for generating and updating the stored positioning data. It is to be understood, however, that a different content and/or structure could be used as well.

The information on terrestrial radio signals determined by the mobile device could comprise for instance only an identification of at least one node transmitting the terrestrial radio signals and/or only an identification of at least one cell served by a node transmitting the terrestrial radio signals. Using such information may have the effect that a position of the mobile device, possibly along with an indication of an uncertainty, may be determined with little processing load. For instance, if the stored information indicates an estimated coverage area for various nodes and/or cells, the center of the area for the identified node or cell could be the estimated location of the mobile device, and the size of the area could define the uncertainty of the estimate.

In addition, the information on terrestrial radio signals provided by the mobile device could comprise for instance an indication of a measured received signal strength of the terrestrial radio signals, like an RSSI or an Rx level value, and/or an indication of a measured pathloss of the terrestrial radio signals, an indication of a timing advance of the terrestrial radio signals, an indication of a round-trip-time of the terrestrial radio signals, etc. Using such more comprehensive information as a basis for estimating the location of a mobile device based on stored information may have the effect that the location of the mobile device may be estimated more accurately, for instance using radio channel models that have been defined based on corresponding information from mobile devices.

A radio channel model for a node or for a cell may comprise for instance the position of a node and a pathloss model or received signal strength model for the signals transmitted by the node. A pathloss model may indicate an expected pathloss of signals transmitted by a node as a function of a distance to the position of the node. Similarly, a received signal strength model may indicate an expected received signal strength of signals transmitted by a node as a function of a distance to the position of the node. Such models may be defined by values of parameters that are stored for a respective model.

In an exemplary embodiment, the value of the at least one determined quality parameter is stored. This may have the effect that it may be used in a statistical evaluation together with corresponding values that are determined at an earlier and/or later point of time, for instance once sufficient values have been collected for a meaningful statistic.

In an exemplary embodiment, the value of the at least one quality parameter is included in a statistical evaluation. This statistical evaluation may be a basis for monitoring the quality of positioning data and, optionally, as a basis for controlling the collection and/or storage of positioning data and thus the quality of stored positioning data. The statistical evaluation could equally be a basis for monitoring the quality of the provided positions of mobile devices that are determined based on satellite signals.

The statistical evaluation may be performed on a general basis, in order to obtain a general overview of the quality of stored data. Alternatively or in addition, it may be performed with any desired partitioning. This may have the effect that the statistical evaluation is suited to provide a basis for a well-directed monitoring and/or control of data. Separate statistical evaluations could be performed for example for at least one of: a respective node transmitting terrestrial radio signals, a respective group of nodes transmitting terrestrial radio signals, a respective cell in which a node transmits terrestrial radio signals, a respective group of cells in which nodes transmit terrestrial radio signals, a respective region with a country being an example for a respective region, a respective group of regions, a respective operator, a respective group of operators, a respective technology of a network transmitting terrestrial radio signals, a respective group of technologies of networks transmitting terrestrial radio signals, a respective manufacturer of mobile devices, a respective model of mobile devices, a respective group of models of mobile devices, a respective software version implemented in mobile devices, and a respective group of software versions implemented in mobile devices. Any other desired partitioning could be used as well, including any combination of above examples. It would be possible, for instance, to determine a statistical evaluation for a particular technology used by a particular operator, etc.

It is to be understood that the determined value of the at least one quality parameter could also be fed as an input to a continuous statistical evaluation as soon as the value is available, and that only the updated results of the statistical evaluation could be stored.

In an exemplary embodiment, an automatic control of the collection and/or storage of positioning data is performed in response to a statistical evaluation of determined values of at least one quality parameter. This may have the effect that the quality of the stored data may be improved when required. As a result, the user experience may be improved when a user makes use of the stored data for positioning purposes. It may have in addition the effect that memory space and processing load may be limited when the quality is already better than required.

In an exemplary embodiment, the stored positioning data may be stored with a mapping to grid points of the grid. Each grid point may represent a real location, and the data stored with a mapping to a grid point of a grid may be based on information that has been determined by at least one mobile device close to this real location. Performing an automatic control of the storage of positioning data may then comprise changing a density of the grid. Adjusting the grid density may have the effect that more data may be stored when required for achieving a satisfactory quality, and that less data may be stored in order to reduce the amount of stored data when acceptable. A separate grid could be provided for each node or for each cell served by a node. Thus, also the adjustment of the grid density could be performed separately for each node or cell.

Alternatively or in addition, performing an automatic control of a collection of positioning data may comprise causing at least one mobile device to change a frequency of providing information on terrestrial radio signals from at least one node for updating the stored positioning data. This may have the effect that more information from mobile devices on terrestrial radio signals may be obtained and processed when needed. At the same time, this may have the effect that processing load may be limited to an amount that is required for achieving an acceptable quality of stored positioning data.

In an exemplary embodiment, the at least one quality parameter relates to at least to one of the following: an accuracy of a provided location in the response compared to the satellite signal based position, an availability of stored positioning information, a coverage of the stored positioning data, a consistency of an uncertainty indicated for a location in the response compared to an actual uncertainty, and a presence of a fallback case in which a position of the mobile device can only be determined based on stored positioning data using one of at least two positioning services. Each of these parameters may be suited to provide or contribute to information on the quality of the stored positioning data.

In an exemplary embodiment, the at least one quality parameter relates alternatively or in addition to at least to one of the following: an accuracy of the satellite signal based position and a coverage of a satellite signal based positioning. Each of these parameters may be suited to provide or contribute to information on the quality of a satellite signal based positioning at the mobile device.

In an exemplary embodiment, the information on terrestrial radio signals is received from the mobile device in a message, the message comprising in addition a timestamp, an indication of a mobile device model and/or an indication of a mobile device software version. The information on the mobile device model and/or on a mobile device software version may allow comparing the quality of a satellite signal based positioning that is achieved with different devices and different software versions. Such an embodiment may be based on the assumption that a position of a mobile device that is determined based on stored positioning data is fairly accurate.

In an exemplary embodiment, generating at least one request for determination of a location of the mobile device comprises generating a plurality of requests for determination of a location of the mobile device based on information on terrestrial radio signals from different nodes provided by the mobile device. Each request may include information on terrestrial radio signals from one or more nodes. Generating different requests for different nodes may have the effect that the quality of stored positioning data can be estimated separately for different nodes or different groups of nodes. The requests may be processed by a single service or by different services, either in the apparatus generating the request, at a single server external to the apparatus generating the request, or at different servers.

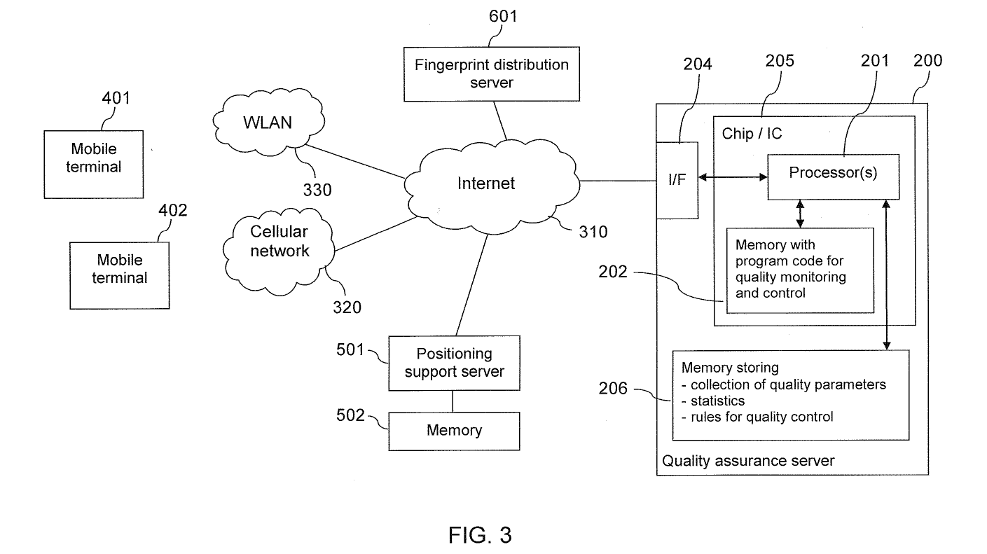

FIG. 3 is a schematic block diagram of a system enabling monitoring and controlling the quality of stored positioning data.

The system comprises a quality assurance server 200. Server 200 is connected to a network 310, for example the Internet. The system comprises in addition at least one positioning support server 501 and at least one fingerprint distribution server 601, which are equally connected to network 310. The at least one positioning support server 501 is further connected to at least one memory 502 including positioning databases. The system further comprises a plurality of mobile terminals 401, 402 that can be connected to network 310 via a cellular communication network 320 or via any of a plurality of WLANs 330.

Mobile terminals 401, 402 may comprise a global navigation satellite system (GNSS) receiver, for instance a GPS receiver. Mobile terminals 401, 402 may further comprise a cellular engine and a WLAN engine. Mobile terminals 401, 402 may further comprise software code and/or logic configured to cause or perform measurements on signals from nodes of cellular communication network 320 and/or WLANs 330 and to cause reports of measurement results in the form of fingerprints to a fingerprint distribution server 601.

The at least one fingerprint distribution server 601 is configured to collect fingerprints provided by mobile terminals 401, 402 and to forward the fingerprints to a positioning server 501 or to quality assurance server 200. For reasons of easier reference, it will be assumed in the following that there is a single fingerprint distribution server 601.

The at least one positioning support server 501 provides or supports a learning system for building up and updating a positioning data learning database, for instance a fingerprint database. The at least one positioning server 501 is configured to receive fingerprints from server 601, to process the fingerprint data for storage, and to store the data in at least one fingerprint database in the at least one memory 502. The at least one positioning support server 501 is further configured to compute and store further models based on collected and stored fingerprint data in further databases in the at least one memory 502. The at least one positioning support server 501 is further configured to support a positioning of mobile terminals. The at least one positioning support server 501 could be configured for instance to receive a location request, to determine a location of a mobile terminal based on data stored in memory 502 and on data in the location request, and to provide a location response including the determined location.

The at least one positioning support server 501 may comprise a single server or, for instance, one or more dedicated position data learning servers taking care of collecting and processing positioning data, one or more dedicated positioning servers taking care of positioning operations, and possibly some other kind of servers. The at least one memory 502 could comprise a single memory or a plurality of memories. Separate servers and associated memories could be provided for instance for data on WLAN nodes, for data on WLAN nodes in different regions or countries, for data on cellular nodes of different operators, for data on cellular nodes in different regions or countries, etc. There could also be different memories for collected fingerprint data on the one hand and for processed data, for instance coverage area model data and radio channel model data, on the other hand. For reasons of easier reference, it will be assumed in the following that there is a single positioning support server 501 and a single memory 502.

Quality assurance server 200 is configured to monitor and control the quality of stored positioning data. The functions of server 200 could also be integrated in any other kind of server.

Server 200 comprises a processor 201 that is linked to a first memory 202, to a second memory 206 and to an interface (I/F) 204. Processor 201 is configured to execute computer program code, including computer program code stored in memory 202, in order to cause server 200 to perform desired actions.

Memory 202 stores computer program code for supporting a monitoring and controlling of a quality of stored positioning data and optionally computer program code for controlling the quality of a GNSS based positioning at different mobile terminals. The computer program code may comprise for example at least similar program code as memory 102. In addition, memory 202 may store computer program code implemented to realize other functions, as well as any kind of other data. It is to be understood, though, that program code for any other actions than supporting a monitoring of the quality of stored data could also be implemented on one or more other physical and/or virtual servers.

Processor 201 and memory 202 may optionally belong to a chip or an integrated circuit 205, which may comprise in addition various other components, for instance a further processor or memory.

Memory 206 stores at least one database that can be accessed by processor 201. The database is configured to store values of quality parameters, results of statistical evaluations of these quality parameters, and rules for a quality control based on the results of statistical evaluations. In addition, memory 206 could store other data. It is to be understood that a memory storing the at least one database could also be external to server 200; it could be for instance on another physical or virtual server.

Interface 204 is a component which enables server 200 to communicate with other devices, like fingerprint distribution server 601 and positioning support server 501 via network 310. Interface 204 could comprise for instance a TCP/IP socket.

Server 200 could comprise in addition a positioning application programming interface (API), which may interact with an external server, for instance server 501, via interface 204.

Component 205 or server 200 could correspond to exemplary embodiments of an apparatus according to the invention.

Cellular communication network 320 comprises a plurality of base stations or cell towers operating as nodes of the network. Each WLAN 320 comprises at least one access point as a node of a communication network. Each of the nodes transmits signals that can be observed in certain associated area. In the case of cellular communication network 320, the area may comprise the areas of one or more cells.

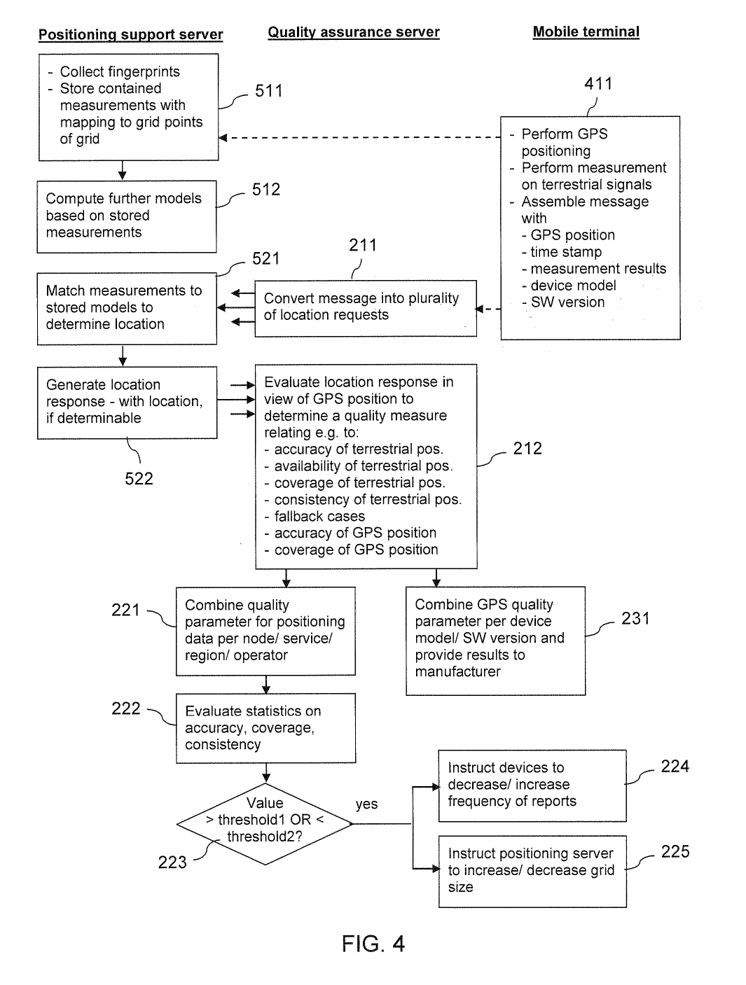

An exemplary operation in the system of FIG. 3 will now be described with reference to the flow chart of FIG. 4. Actions at mobile device 401 are presented on the upper right hand side. Actions at positioning support server 501 are presented on the upper left hand side. Actions at quality assurance server 200 are presented essentially in the center. Processor 201 and the program code stored in memory 202 cause server 200 to perform the presented operations when the program code is retrieved from memory 202 and executed by processor 201.

Mobile terminal 401 may receive GPS signals and determine its current position based on the GPS signals. In addition, mobile terminal 401 may detect signals transmitted by one or more nodes of cellular communication network 320 and perform measurements on these signals. Mobile device 401 may assemble results of measurements on these signals as “fingerprint” data in a message. The measurement results may include for instance and a direct or indirect identification of a respective node from which signals have been received, for instance in the form of a global cell identity and/or a local cell identity, and an indication of a received signal strength “Rx level” for each node. The message may further include an indication of the GPS based location at the time of measurement, a time stamp indicating the time of measurement, etc. (action 411) Alternatively or in addition, mobile terminal 401 may detect signals transmitted by access points (AP) of one or more WLANs 330, and include results of measurements on these signals in the message along with a respective identity of a WLAN AP. The message could further include an indication of a device model and/or an indication of a software version implemented in the mobile terminal for the satellite based positioning. Mobile device 401 may then transmit the message to server 601. The transmission may take place via WLAN 330 and network 310 or via cellular network 320 and network 310. It has to be noted that in an alternative embodiment, the position of mobile device 401 could also be determined based on some other positioning technology than GNSS. For instance, if mobile terminal 401 collects only results of measurements on signals from cellular communication network 320, mobile terminal 401 could determine its position based on WLAN signals instead of GNSS signals. Mobile terminal 401 may transmit similar messages from various locations to server 601 while moving around.

The radio measurements are preferably performed for all radio interfaces available in mobile terminal 401, but in practice the measurements may be limited to those radio interfaces already in use, in order to save power at mobile terminal 401.

In addition, other mobile terminals, for instance mobile terminal 402, may transmit corresponding messages to server 601.

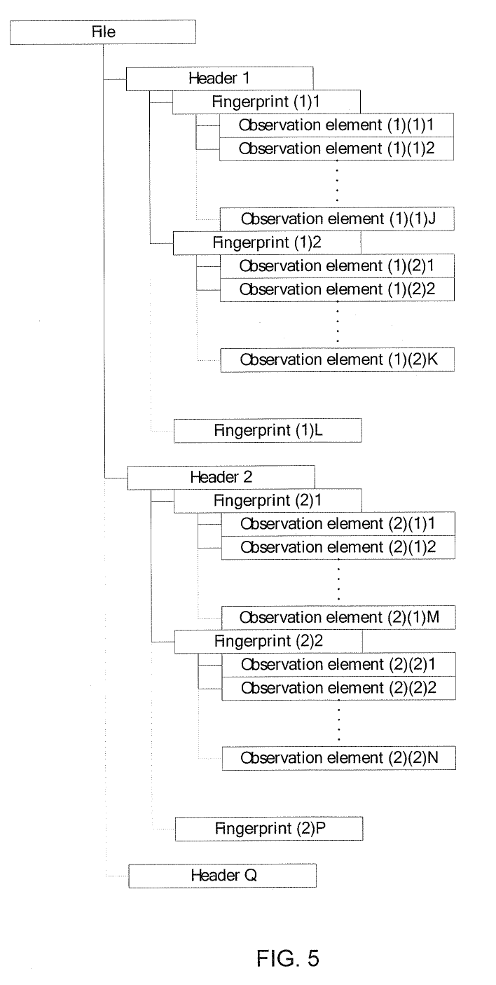

FIG. 5 illustrates an exemplary fingerprint data structure that may be used by mobile terminals 401, 402 for transmission to server 601. The file structure is defined for the case that mobile terminals collect a number of fingerprints before transmitting them to server 601. A file that is transmitted by mobile device 401 to server 601 may include a plurality of headers 1 to Q, with Q being a natural number. Each header may optionally contain information about the home network and possibly some data unique to the current user of the mobile terminal. For instance, it is possible that there are multiple “users” for the same mobile terminal, which may be separated by the headers. This could be for instance the case if the user changes the subscriber identity module (SIM) card or if the device may contain more than one SIM card at the same time. Each header may include in addition information about the type of mobile device 401, for instance an indication of the phone model, its firmware version, etc. The file may further comprise various fingerprints (1)1, to (1)L, or (2)1, to (2)P, etc., determined at different points of time, with L and P being natural numbers. Each fingerprint is associated to the header that contains data that was relevant at the time at which the fingerprint was determined. Each fingerprint comprises one or more observation elements (1)(1)1 to (1)(1)J, etc., with J, K, M, N, shown in FIG. 5 as examples of the numbers of observation elements per fingerprint, being natural numbers. The observation elements of each fingerprint comprise information on a location at which measurements on radio signals were taken, a timestamp and the actual results of measurements on radio signals at the identified time and location. It is to be understood that in case no variable information on the device as such is to be conveyed, all fingerprints could also be associated to a single header.

Server 601 receives messages with fingerprint data and determines for each message whether to use the message for updating positioning data or for checking the quality of positioning data. In the first case, the message is forwarded to server 501; in the latter case, the message is forwarded to server 200. The operation at server 601 is not shown explicitly in FIG. 4, but the alternatives are indicated by arrows with dashed lines. When a message is to be forwarded to one of a plurality of positioning support servers, server 601 could also be responsible for distributing parts of the message to different positioning support servers. For instance, fingerprint parts relating to measurements on WLAN signals could be forwarded to a server 501 that takes care of collecting WLAN data, and fingerprint parts relating to measurements on cellular signals could be forwarded to a server 501 that takes care of collecting cellular data in general or cellular data for a particular cellular network.

When server 501 receives the message or a part of the message, it identifies at least one node or cell for which an Rx level value is included in the message and selects a grid associated to the node or cell. Server 200 further determines the grid point of the grid, which represents a location that is closest to the GPS based position indicated in the message. (action 511) Server 501 stores the received Rx level values and associated data with a mapping to the determined grid point in a fingerprint database in memory 502. By storing data from a large number of similar messages or parts of messages provided by a large number of mobile terminals, server 501 may build up and update a fingerprint database with comprehensive positioning data. It is to be understood that the message does not have to comprise Rx level values or similar. It could also comprise the identification of the node or cell as a measurement result only. In this case, the determined grid point could simply be marked as a grid point representing a location at which signals from the identified node or cell have been received.

Server 501 may use the positioning data that is stored in the fingerprint database for regularly updating further models for each node or cell. (action 512) Updated parameter values of those further models are equally stored in memory 502. A coverage area model could comprise for instance an estimated node location and an indication of a range of the transmissions of the node, and thus the coverage area of the node. A radio channel model could comprise for instance an estimated node location and parameter values defining a received signal strength model or a pathloss model. Parameter values for a received signal strength model or for a pathloss model may be determined based on stored Rx level values or, alternatively, stored pathloss values.

When server 200 receives the message from server 601, it converts the message into one or more location requests. (action 211) For example, a separate location request could be generated based on results of measurements for a current serving cell of cellular communication network 320, based on results of measurements for a current serving cell and for neighbor cells of cellular communication network 320 or based on results of measurements for all cells of cellular communication network 320 identified by the same location area code, and based on results of measurements for WLANs identified by their MAC addresses.

Server 200 transmits the location request or requests to server 501. In case several servers 501 are provided, for instance one for cellular based positioning and one for WLAN based positioning, or different ones for different operators of cellular networks, server 200 determines as well which location request is transmitted to which server 501.

Server 501 receives at least one location request and matches the measurement results for a particular node or cell in the request to a model defined by stored model parameters values for this node or cell, in order to determine the location of mobile device 401. (action 521) The determined location could be for instance the estimated position of the node in a coverage area model and an indicated uncertainty corresponding to the estimated range of the node in the coverage area model. The determined location could also be an estimated distance to the estimated position of the node in a radio channel model, with an indicated uncertainty. The estimated distance and the uncertainty could be determined based on parameter values of the radio channel model. The determined location could also be an estimated location that results from the intersection of estimated distances to estimated locations of a plurality of nodes, in case a single location request comprises measurement results for a plurality of nodes. Furthermore, the location of a mobile device could also be determined based on a mixture of one or more coverage areas and on or more estimated distances.

Server 501 generates for each location request a location response, which includes a determined location of mobile device 401, in case it was possible to determine such location based on the received measurements. (action 522) It may not be possible to determine a location, for instance, in case the location request comprises measurement data for a cell or node for which no data has been stored so far. The location responses are transmitted to server 200.

Server 200 receives the location responses from one or more positioning support servers 501 and evaluates the indicated location or locations, if any, with a view to the GPS based position in the received message of device 401. (action 212)

The evaluation can be used in particular for determining and storing one or more quality measures.

A first possible set of quality measures may relate to the quality of the stored positioning data in memory 502.

The coordinates of a location in the location response may be compared with the GPS position indicated in the message of mobile device 401. The GPS position is assumed to have very good quality, that is, a small uncertainty. The result of the comparison may thus be a measure of the accuracy of the WLAN, cell or neighbor cell positioning and thus of the stored positioning data.

The success or failure to provide a location for mobile device 401 in one of the location responses in a certain area based on a certain type of positioning, for instance WLAN based or cellular based, can be determined. The result may be an indication of the availability of a positioning service using certain databases.

When combining the success or failure to provide a location in addition with the indicated GPS position, the result may be an indication of the coverage of the stored data. The spatial distribution of the fingerprints determines the areas which are covered by a positioning service using certain databases.

An indicated uncertainty of a location in the location response may be compared to the true accuracy of the location response as mentioned above. The result may thus be an indication of the consistency of the stored data.

Furthermore, in case separate location requests were provided for a WLAN based positioning and a cellular positioning, it may be determined whether the current position of mobile device 401 enables for instance a positioning based on WLAN signals, but not based on cellular signals. The result may thus indicate a fallback case.

A second set of quality measures may relate to the quality of the GPS based positioning or any other employed GNSS based positioning. The volume of the crowd-sourced fingerprint data is huge, so that it might be assumed at least for a certain area or network or operator, etc., that a positioning using positioning support server 501 results in a rather accurate location of mobile device 401.

The accuracy of the GPS positioning can be measured by comparing the GPS position of mobile device 401 with a location in one or more location responses. The accuracy of the GPS positioning can be determined for instance per device model or per software version of the device, depending on the available details in the message from mobile device 401.

A rough estimate of the GPS positioning coverage, that is the areas where GPS works and where it does not work, can also be made from the location responses.

If the quality measures relate to the accuracy of the positioning data in memory 502, the values of a respective quality parameter that are determined for one set of location responses after the other may be accumulated or otherwise combined, in order to obtain statistical figures about the accuracy, availability, coverage, consistency and/or fallback cases, etc. (action 221) The combining may be performed for instance per node, per service, per region or per operator, etc. The combining may be performed continuously as the values of quality parameters are determined. Alternatively, it may be performed only once a sufficient number of location responses has been received for a particular node, service, region or operator, etc., to obtain a meaningful statistical figure.

Accuracy values may be combined for instance by averaging.

Availability indications may be used for instance for determining or updating a success-to-failure ratio for a positioning using stored positioning data for a certain node.

Coverage values may be combined spatially to show in which areas the spatial distribution of the fingerprints for a particular positioning service is satisfactory.

Accumulating the uncertainty may be used for determining whether a certain percentage, for example 68%, of the received GPS positions are within the uncertainty reported in the location responses.

Collecting positions enabling and/or requiring a fallback may be used for determining the areas where fallbacks, for instance from cell positioning to WLAN based positioning, are taking place.

The statistical figures on accuracy, coverage, consistency, etc. may be evaluated for determining whether any measures should be taken. (action 222)

Server 200 may determine for instance whether a particular statistical figure exceeds or falls short of a threshold value. (action 223)

For instance, if a determined average accuracy for a node serving a certain area or a determined coverage for a certain area falls short of a predetermined first threshold value (action 223), server 200 may instruct mobile terminals 401, 402 to increase the frequency of reporting fingerprints from this area, in order to promote the learning of more accurate and/or better distributed data. (action 224) Server 200 may be configured for instance to manage or guide a data collection software and/or some logic in mobile terminals 401, 402 to change the current reporting frequency in a particular area.

Alternatively or in addition, server 200 may instruct server 501 to decrease a grid size and thus to increase the density of a grid that is used for storing fingerprint data for a respective node or cell. (action 225) This approach may be used only as an alternative in particular in the case that the reporting frequency is already fairly high. A grid for a particular node or cell could be defined for instance with reference to a reference grid covering the entire surface of Earth. The grid density of the reference grid could be rather high, and the grid for a particular node could be defined by adjustable hop factors i, j, which indicate that only grid points in every i^{th} column and every j^{th} row of the reference grid in a certain area are to be used for a grid for the particular node or cell. It is to be understood that also a single hop factor could be used for latitude and longitude direction. The density of the grid for the particular node or cell could then easily be adjusted by adjusting the hop factor or factors for this grid. Increasing the grid density means that more data can be stored with a mapping to grid points of a grid, which may improve the accuracy of locations of mobile devices that are determined based on the grid data.

On the other hand, if a determined statistical figure exceeds a second predetermined threshold value (action 223), server 200 may instruct mobile devices 401, 402 to reduce the frequency of reports in the area covered by one or more nodes, in order to reduce the processor load at server 200 and server 501. (action 224) Server 200 may further instruct server 501 to increase a grid size that is used for storing fingerprint data for one or more nodes or cells, in order to optimize the size of the database and to minimize processor and/or memory load at server 501. (action 225)

If a monitored statistical value neither falls short of a first threshold value nor exceeds a second threshold value, server 200 may simply continue with determining quality parameter values (actions 211, 212) and with generating or updating and evaluating statistical figures (actions 221, 222, 223).

If the quality measures considered in action 212 relate to the accuracy of GPS positions provided by mobile devices, server 200 may combine the values of a respective quality parameter that are determined for one set of location responses after the other, in order to obtain statistical figures about the GPS accuracy and GPS coverage. In an exemplary embodiment, only location responses with locations that have been determined based on stored WLAN data may be considered, since a WLAN based positioning may be more accurate than a cell based positioning. The combining may be performed for instance per mobile device type and/or per software version of the mobile devices. (action 231) The combining may be performed continuously as the values of quality parameters are determined. Alternatively, it may be performed only once a sufficient number of location responses has been received for a particular device type or software version, etc., to obtain a meaningful statistical figure.

The resulting statistical figures may be transmitted for instance at regular intervals to registered device manufacturers, or they may be provided for retrieval by device manufacturers. The statistical figures may enable manufacturers for instance to determine whether certain devices and/or certain software versions result in different GPS based positioning accuracies or coverage.

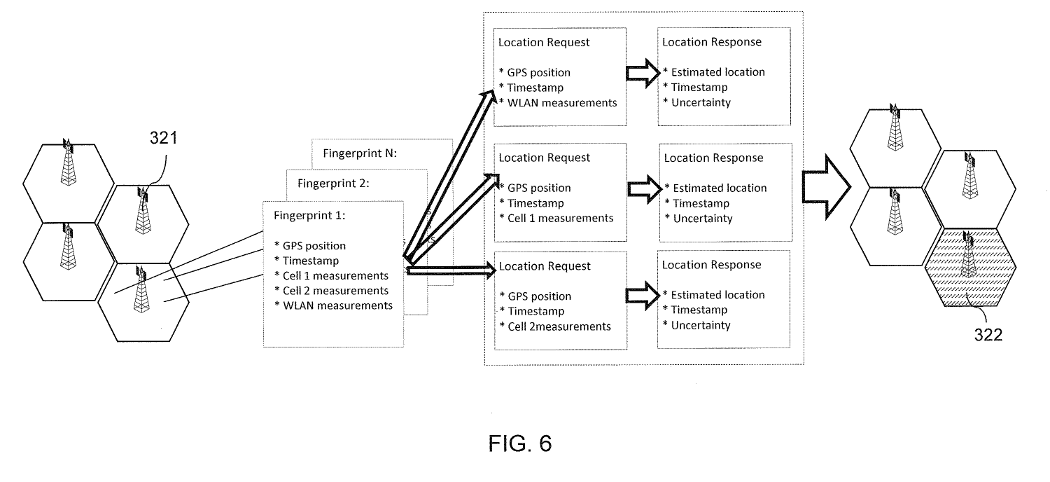

FIG. 6 is a diagram summarizing the operations in the system of FIG. 3, which relate to the monitoring of a quality of stored data, using a somewhat different representation.

Cell towers 321 serving a respective cell and WLAN access points (not shown) transmit signals that are received by mobile terminals. The mobile terminals generate a respective fingerprint for a particular location, which is determined by a GPS based positioning, and for a particular time, which is recorded as a timestamp.

Server 200 receives crowd-sourced fingerprints from different locations in the network at different points of times. Fingerprints 1 to N are depicted. Fingerprint 1 comprises by way of example an indication of a GPS position, a timestamp, measurement results for a first cell 1, measurement results for a second cell 2, and measurement results for a WLAN access point.

Server 200 converts Fingerprint 1 into three location requests. Each request comprises the results of one type of radio measurements, but the same GPS reference and timestamp. All other fingerprints are converted into location requests in the same manner.

Positioning servers 501 produce responses to each location request. Each location response comprises an estimated location or no location, a timestamp and an indication of an uncertainty of the estimated location, if any.

The location responses are used at server 200 together with the GPS positions to monitor for instance the true positioning accuracy per cell. The result may be that the accuracy is satisfactory in some of the cells, but not satisfactory in other cells 322 marked by hachure, so that certain measures may be taken to improve the positioning accuracy that can be achieved with the stored data for this cell.

Certain embodiments of the invention may thus have the effect that fingerprint data inflow can be utilized both for learning and for quality monitoring and control. No additional functionality is needed in the mobile devices to this end. Existing fingerprint collection software and the collected fingerprint data structure used by mobile devices can be directly employed for quality assurance purposes. No additional functionality is needed at a positioning server either, if the same location request is used as for a regular positioning of mobile devices. Certain embodiments of the invention may enable an autonomous control of key quality parameters contributing directly to the end-user experience. The extra load required for the quality monitoring can be processed for example during the night time when the load is lower in general.

It has to be understood that also a mobile terminal might benefit from an implementation supporting a monitoring of a quality of positioning data. Such a mobile terminal could be used by a provider of a positioning service for selectively checking the quality of his database, for example as a basis for determining when a new wardriving collection is appropriate.

It may be noted that also mobile terminals with GNSS capability may benefit from using cellular/non-cellular positioning technologies, in order to accelerate the time-to-first-fix, using the obtained location as reference location, or in order to reduce the power consumption. Furthermore, not all applications require a GNSS based position. Furthermore, positioning technologies that are based on terrestrial radio signals may be better suited to work indoors than positioning technologies that are based on satellite signals.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:
(a) hardware-only circuit implementations (such as implementations in only analog and/or digital circuitry)
(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory, a random access memory, a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The functions illustrated by processor 101 or 201 in combination with memory 102 or 202, respectively, or the integrated circuit 205 can also be viewed as means for generating at least one request for determination of a location of a mobile device based on information on terrestrial radio signals determined by the mobile device and based on stored positioning data, wherein the stored positioning data is based on information on terrestrial radio signals provided by at least one mobile device; and as means for determining a value of at least one quality parameter by evaluating a response to the request in view of an indication of a position of the mobile device that has been determined based on satellite signals.

The program codes in memory 102 and 202, respectively, can also be viewed as comprising such means in the form of functional modules.

FIGS. 2 and 4 may also be understood to represent exemplary functional blocks of computer program codes or of hardware circuitries supporting a monitoring of the quality of information.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an exemplary embodiment in a particular category may also be used in a corresponding manner in an exemplary embodiment of any other category.

1-24. (canceled)

25. A method comprising at an apparatus:
generating at least one request for determination of a location of a mobile device based on information on terrestrial radio signals determined by the mobile device and based on stored positioning data, wherein the stored positioning data is based on information on terrestrial radio signals provided by at least one mobile device; and
determining a value of at least one quality parameter by evaluating a response to the request in view of an indication of a position of the mobile device that has been determined based on satellite signals.

26. The method according to claim 25, wherein the information on terrestrial radio signals comprises at least one of:
an identification of at least one node transmitting the terrestrial radio signals;
an identification of at least one cell served by a node transmitting the terrestrial radio signals;
an indication of a received signal strength of the terrestrial radio signals;
an indication of a pathloss of the terrestrial radio signals;
an indication of a timing advance of the terrestrial radio signals; and
an indication of a round-trip-time of the terrestrial radio signals.

27. The method according to claim 25, further comprising at least one of storing the value of the at least one quality parameter and using the value of the at least one quality parameter in a statistical evaluation.

28. The method according claim 25, further comprising including the value of the at least one quality parameter in a separate statistical evaluation for at least one of:
a respective node transmitting terrestrial radio signals;
a respective group of nodes transmitting terrestrial radio signals;
a respective cell in which a node transmits terrestrial radio signals;
a respective group of cells in which nodes transmit terrestrial radio signals;
a respective region;
a respective group of regions;
a respective country;
a respective operator;
a respective group of operators;
a respective technology of a network transmitting terrestrial radio signals;
a respective group of technologies of networks transmitting terrestrial radio signals;
a respective manufacturer of mobile devices;
a respective model of mobile devices;
a respective group of models of mobile devices;
a respective software version implemented in mobile devices; and
a respective group of software versions implemented in mobile devices.

29. The method according to claim 25, further comprising performing an automatic control of at least one of a collection and a storage of the positioning data in response to a statistical evaluation of determined values of the at least one quality parameter.

30. The method according to claim 29, wherein performing an automatic control of at least one of a collection and a storage of the positioning data comprises at least one of:
causing a change of a density of a grid, wherein the stored positioning data is stored with a mapping to grid points of the grid; and
causing at least one mobile device to change a frequency of providing information on terrestrial radio signals from at least one node for updating the stored positioning data.

31. The method according to claim 25, wherein the at least one quality parameter relates to at least to one of:
an accuracy of a provided location in the response compared to the satellite signal based position;
an availability of stored positioning data;
a coverage of stored positioning data;
a consistency of an uncertainty indicated for a location in the response compared to an actual uncertainty;
a presence of a fallback case in which a position of the mobile device can only be determined based on stored positioning data using one of at least two positioning services;
an accuracy of the satellite signal based position; and
a coverage of a satellite signal based positioning.

32. The method according to claim 25, wherein the information on terrestrial radio signals is received from the mobile device in a message, the message comprising in addition at least one of:
a timestamp;
a mobile device model;
a mobile device software version.

33. The method according to claim 25, wherein generating at least one request for determination of a location of the mobile device comprises generating a plurality of requests for determination of a location of the mobile device based on information on terrestrial radio signals from different nodes determined by the mobile device.

34. An apparatus comprising at least one processor and at least one memory including computer program code, the at least one memory and the computer program code configured to, with the at least one processor, cause an apparatus at least to perform:
generate at least one request for determination of a location of a mobile device based on information on terrestrial radio signals determined by the mobile device and based on stored positioning data, wherein the stored positioning data is based on information on terrestrial radio signals provided by at least one mobile device; and
determine a value of at least one quality parameter by evaluating a response to the request in view of an indication of a position of the mobile device that has been determined based on satellite signals.

35. The apparatus according to claim 34, wherein the information on terrestrial radio signals comprises at least one of:
an identification of at least one node transmitting the terrestrial radio signals;
an identification of at least one cell served by a node transmitting the terrestrial radio signals;
an indication of a received signal strength of the terrestrial radio signals;
an indication of a pathloss of the terrestrial radio signals;
an indication of a timing advance of the terrestrial radio signals; and
an indication of a round-trip-time of the terrestrial radio signals.

36. The apparatus according to claim 34, wherein the at least one memory and the computer program code is configured to, with the at least one processor, cause the apparatus to at least one of store the value of the at least one quality parameter and use the value of the at least one quality parameter in a statistical evaluation.

37. The apparatus according to claim 34, wherein the at least one memory and the computer program code is configured to, with the at least one processor, cause the apparatus to include the value of the at least one quality parameter in a separate statistical evaluation for at least one of:
a respective node transmitting terrestrial radio signals;
a respective group of nodes transmitting terrestrial radio signals;
a respective cell in which a node transmits terrestrial radio signals;
a respective group of cells in which nodes transmit terrestrial radio signals;
a respective region;
a respective group of regions;
a respective country;
a respective operator;
a respective group of operators;
a respective technology of a network transmitting terrestrial radio signals;
a respective group of technologies of networks transmitting terrestrial radio signals;
a respective manufacturer of mobile devices;
a respective model of mobile devices;
a respective group of models of mobile devices;
a respective software version implemented in mobile devices; and
a respective group of software versions implemented in mobile devices.

38. The apparatus according to claim 34, wherein the at least one memory and the computer program code is configured to, with the at least one processor, cause the apparatus to perform an automatic control of at least one of a collection and a storage of the positioning data in response to a statistical evaluation of determined values of the at least one quality parameter.

39. The apparatus according to claim 38, wherein performing an automatic control of at least one of a collection and a storage of the positioning data comprises at least one of:
causing a change of a density of a grid, wherein the stored positioning data is stored with a mapping to grid points of the grid; and
causing at least one mobile device to change a frequency of providing information on terrestrial radio signals from at least one node for updating the stored positioning data.

40. The apparatus according to claim 34, wherein the at least one quality parameter relates to at least to one of:
an accuracy of a provided location in the response compared to the satellite signal based position;
an availability of stored positioning data;
a coverage of stored positioning data;
a consistency of an uncertainty indicated for a location in the response compared to an actual uncertainty;
a presence of a fallback case in which a position of the mobile device can only be determined based on stored positioning data using one of at least two positioning services;
an accuracy of the satellite signal based position; and
a coverage of a satellite signal based positioning.

41. The apparatus according to claim 34, wherein the information on terrestrial radio signals is received from the mobile device in a message, the message comprising in addition at least one of:
a timestamp;
a mobile device model;
a mobile device software version.

42. The apparatus according to claim 34, wherein the at least one memory and the computer program code is configured to, with the at least one processor, cause the apparatus to generate, as the at least one request for determination of a location of the mobile device, a plurality of requests for determination of a location of the mobile device based on information on terrestrial radio signals from different nodes determined by the mobile device.

43. The apparatus according to claim 34, wherein the apparatus is one of:
a server;
a component for a server;
a mobile terminal; and
a component for a mobile terminal.

44. A non-transitory computer readable storage medium in which computer program code is stored, the computer program code when executed by a processor causing an apparatus to perform the following:
generating at least one request for determination of a location of a mobile device based on information on terrestrial radio signals determined by the mobile device and based on stored positioning data, wherein the stored positioning data is based on information on terrestrial radio signals provided by at least one mobile device; and
determining a value of at least one quality parameter by evaluating a response to the request in view of an indication of a position of the mobile device that has been determined based on satellite signals.
